(19) United States
(12) Patent Application Publication
(10) Pub. No.: US 2026/0167203 A1
(43) Pub. Date: Jun. 18, 2026

(54) OBJECT RECOGNITION METHOD USING ULTRASONIC DATA AUGMENTED BY HETEROGENEOUS SENSOR FUSION AND VEHICLE

(71) Applicants: Hyundai Motor Company, Seoul (KR); Kia Corporation, Seoul (KR)

(72) Inventors: Jun Hyung KIM, Hwaseong-Si (KR); Da Ye OH, Hwaseong-Si (KR); Jun Ho KOH, Hwaseong-Si (KR)

(21) Appl. No.: 19/399,064

(22) Filed: Nov. 24, 2025

(30) Foreign Application Priority Data
Dec. 17, 2024 (KR) 10-2024-0188425

(51) Int. Cl. B60W 50/00; B60W 40/04; B60W 60/00; G01S 13/58; G01S 13/86; G01S 15/58; G01S 15/86; G06V 10/26; G06V 10/77; G06V 10/80; G06V 20/58

(52) U.S. Cl. CPC B60W 50/0097; B60W 40/04; G01S 13/581; G01S 13/862; G01S 15/58; G01S 15/86; G06V 10/806; G06V 20/58; B60W 60/001; B60W 2420/403; B60W 2420/408; B60W 2420/54; B60W 2554/4041; B60W 2554/4042; B60W 2554/4046; B60W 2554/802; B60W 2556/35; B60W 2556/40; G06V 10/26; G06V 10/7715

(57) ABSTRACT

Disclosed herein is an object recognition method using ultrasonic data augmented by heterogeneous sensor fusion and vehicle. The method may include generating, based on sensor fusion of ultrasonic data and heterogeneous sensor data acquired from a plurality of sensors of the vehicle, speed information associated with each cell of a view map representing a surrounding environment of the vehicle. The speed information may indicate a speed of the dynamic object corresponding to the cell. The method may further include: adjusting, based on a behavior of a dynamic object in the view map, a position of a cell, of the view map, corresponding to the dynamic object in the surrounding environment; generating, based on speed information of the position-adjusted cell, pseudo-ultrasonic data; recognizing, based on the pseudo-ultrasonic data and subsequent heterogeneous sensor data, an object in the surrounding environment; and controlling, based on the recognized object, an operation of the vehicle.

### CROSS-REFERENCE TO RELATED APPLICATION

This application claims priority to and the benefit of Korean Patent Application No. 10-2024-0188425, filed on Dec. 17, 2024, the disclosure of which is incorporated herein by reference in its entirety.

### TECHNICAL FIELD

The present disclosure relates to vehicle automation, and more specifically to object recognition using heterogeneous sensors.

### BACKGROUND

Vehicles may include various functions for driving convenience. For example, modern vehicles may feature autonomous driving functions. Autonomous driving functions may enable vehicles to control driving with minimal or no driver intervention.

A vehicle may recognize the surrounding environment using information acquired by various types of heterogeneous sensors and identify a situation occurring around the vehicle based on the recognized surrounding environment. The vehicle may establish a control plan for autonomous driving corresponding to the identified situation and control one or more actuators of the vehicle.

Some of the sensors that are most often equipped in vehicles may include, for example, image sensors, radar sensors, and ultrasonic sensors for their relative low costs and simple implementations. Since the radar and ultrasonic sensors are typically less expensive per unit than a lidar sensor, some vehicles may be provided with image, radar, and/or ultrasonic sensors only and without a lidar sensor.

The sensors may have limitations due to their own characteristics. The image sensor, for example, can output high-resolution data but may be ill-suited for providing speed information. The radar sensor can provide speed information but may perform at a lower resolution and cannot provide high-resolution data. The ultrasonic sensor may be useful in a short-range area but may not be able to provide continuous environmental information due to a long acquisition cycle and sparseness (e.g., lower resolution) of data. For accurate environmental recognition, the recognition processing may benefit from linking (e.g., combining, integrating, etc.) data acquired from an array of heterogenous sensor types rather than relying on data individually acquired from each sensor. However, due to the long acquisition cycle and sparseness of data that the ultrasonic sensor typically outputs, its data may be more difficult to integrate with data acquired from other sensor types.

The matters described in this Background section are only for enhancement of understanding of the background of the disclosure, and should not be taken as acknowledgement that they correspond to prior art already known to those skilled in the art.

### SUMMARY

The present disclosure is directed to providing an object recognition method that augments ultrasonic sensor data based on fusion information of heterogeneous sensors, thereby increasing the accuracy of object recognition and increasing the usability of ultrasonic sensor data, and a vehicle.

Objects of the present disclosure are not limited to the above-described object, and other objects that are not described will be able to be clearly understood by those skilled in the art to which the present disclosure pertains based on the following description.

According to one or more example embodiments of the present disclosure, a method, performed by a device associated with a vehicle, may include generating, based on sensor fusion of ultrasonic data and heterogeneous sensor data acquired from a plurality of sensors of the vehicle, speed information associated with each cell of a view map. The view map may represent a surrounding environment of the vehicle. The speed information may indicate a speed of the dynamic object corresponding to the cell. The method may further include: adjusting, based on a behavior of a dynamic object in the view map, a position of a cell, of the view map, corresponding to the dynamic object in the surrounding environment; generating, based on speed information of the position-adjusted cell, pseudo-ultrasonic data; recognizing, based on the pseudo-ultrasonic data and subsequent heterogeneous sensor data, an object in the surrounding environment; and controlling, based on the recognized object, an operation of the vehicle.

The ultrasonic data may be acquired from an ultrasonic sensor, and the heterogeneous sensor data may be acquired from at least one of an image sensor or a radar sensor.

The heterogeneous sensor data may be acquired from at least a radar sensor. The speed information associated with each cell may be generated further based on a Doppler speed, of the object, detected by the radar sensor. The Doppler speed may be a speed detected based on a Doppler shift of data acquired by the radar sensor.

The behavior of the dynamic object may be estimated based on motion data of the dynamic object and a size of the dynamic object.

Adjusting the position of the cell may include determining the cell inside a patch of cells of the view map. The patch of cells may be located around one or more cells, of the view map, that correspond to the device. A size of the patch of cells may be based on a detection range of an ultrasonic sensor that generates the ultrasonic data.

Generating the pseudo-ultrasonic data may include determining, based on the speed information associated with the position-adjusted cell, an estimated distance between the device and the dynamic object.

Generating the pseudo-ultrasonic data may include: determining, based on the speed information associated with the position-adjusted cell, an estimated cell, of the view map, corresponding to a predicted position associated with the pseudo-ultrasonic data; and generating, based on speed information associated with the estimated cell, the pseudo-ultrasonic data.

An acquisition cycle of the ultrasonic data may be longer than an acquisition cycle of the heterogeneous sensor data.

The view map may include a bird's eye view map of the device and the surrounding environment as viewed from above the device.

Recognizing the object may include performing, based on the pseudo-ultrasonic data and the subsequent heterogeneous sensor data, at least one of object detection processing or semantic segmentation processing.

According to one or more example embodiments of the present disclosure, a vehicle may include: a plurality of sensors including: an ultrasonic sensor configured to output ultrasonic data associated with a surrounding environment of the vehicle, and a heterogeneous sensor array configured to output heterogeneous sensor data associated with the surrounding environment of the vehicle; a processor; and a memory storing at least one instruction. The at least one instruction may be configured, when executed by the processor communicating with the memory, to cause the vehicle to:
generate, based on sensor fusion of the ultrasonic data and the heterogeneous sensor data, speed information associated with each cell of a view map; adjust, based on a behavior of a dynamic object in the view map, a position of a cell, of the view map, corresponding to the dynamic object in the surrounding environment; generate, based on speed information associated with the position-adjusted cell, pseudo-ultrasonic data; recognize, based on the pseudo-ultrasonic data and subsequent heterogeneous sensor data, an object in the surrounding environment; and control, based on the recognized object, an operation of the vehicle. The view map may represent the surrounding environment.

The heterogeneous sensor array may include at least one of an image sensor or a radar sensor.

The heterogeneous sensor array may include at least a radar sensor. The speed information associated with each cell may be generated further based on a Doppler speed, of the object, detected by the radar sensor. The Doppler speed may be a speed detected based on a Doppler shift of data acquired by the radar sensor.

The behavior of the dynamic object may be estimated based on motion data of the dynamic object and a size of the dynamic object.

The at least one instruction may be configured, when executed by the processor communicating with the memory, to cause the vehicle to adjust the position of the cell by determining the cell inside a patch of cells of the view map. The patch of cells may be located around one or more cells, of the view map, that correspond to the vehicle. A size of the patch of cells may be based on a detection range of the ultrasonic sensor.

The at least one instruction may be configured, when executed by the processor communicating with the memory, to cause the vehicle to generate the pseudo-ultrasonic data by: determining, based on the speed information associated with the position-adjusted cell, an estimated distance between the vehicle and the dynamic object.

The at least one instruction may be configured, when executed by the processor communicating with the memory, to cause the vehicle to generate the pseudo-ultrasonic data by: determining, based on the speed information associated with the position-adjusted cell, an estimated cell, of the view map, corresponding to a predicted position associated with the pseudo-ultrasonic data; and generating, based on speed information associated with the estimated cell, the pseudo-ultrasonic data.

An acquisition cycle of the ultrasonic data may be longer than an acquisition cycle of the heterogeneous sensor data.

The view map may include a bird's-eye view map of the vehicle and the surrounding environment as viewed from above the vehicle.

The at least one instruction may be configured, when executed by the processor communicating with the memory, to cause the vehicle to recognize the object by: performing, based on the pseudo-ultrasonic data and the subsequent heterogeneous sensor data, at least one of object detection processing or semantic segmentation processing.

### BRIEF DESCRIPTION OF THE DRAWINGS

The above and other objects, features, and advantages of the present disclosure will become more apparent to those of ordinary skill in the art by describing one or more example embodiments thereof in detail with reference to the accompanying drawings, in which:

FIG. 1 is a view showing an example vehicle that communicates with another device to transmit and receive data;

FIG. 2 is a view showing modules constituting an example vehicle;

FIG. 3 is a schematic view showing an example processor for object recognition using ultrasonic data augmented by heterogeneous sensor fusion;

FIG. 4 is a view showing modules constituting an example server;

FIG. 5 is a flowchart of an example object recognition method using ultrasonic data augmented by heterogeneous sensor fusion;

FIG. 6 is a view showing a location detected based on example ultrasonic data;

FIG. 7 is a view showing an example view map including speed information;

FIG. 8 is a view showing an example process of identifying a dynamic object around a vehicle;

FIG. 9 is a view showing an example process of adjusting a position of a cell of the dynamic object; and

FIG. 10 is a view showing an example process of predicting an estimated cell corresponding to a position of pseudo-ultrasonic data.

### DETAILED DESCRIPTION

Hereinafter, one or more example embodiments of the present disclosure will be described in detail with reference to the accompanying drawings so that those skilled in the art may easily implement the present disclosure. However, the present disclosure may be implemented in various different ways, and is not limited to the example embodiment(s) described therein.

In describing the example embodiment(s) of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in one example embodiment could be termed a second element in another example embodiment, and, similarly, a second element in one example embodiment could be termed a first element in another example embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiment(s) are included in the scope of the present disclosure.

In the present disclosure, elements described in various example embodiment(s) do not necessarily mean essential elements, and some of them may be optional elements. Therefore, an example embodiment composed of a subset of elements described in another example embodiment is also included in the scope of the present disclosure. In addition, example embodiment(s) including other elements in addition to the elements described in the various example embodiment(s) are also included in the scope of the present disclosure.

The advantages and features of the present disclosure and the way of attaining them will become apparent with reference to one or more example embodiments described herein in detail in conjunction with the accompanying drawings. Example embodiment(s), however, may be embodied in many different forms and should not be constructed as being limited to the example embodiment(s) set forth herein. Rather, the example embodiment(s) are provided so that this disclosure will be complete and will fully convey the scope of the disclosure to those skilled in the art.

In the present disclosure, each of phrases such as “A or B”, “at least one of A and B”, “at least one of A or B”, “A, B or C”, “at least one of A, B and C”, “”at Each of the phrases such as “at least one of A, B or C” and “at least one of A, B, C or combination thereof” may include any one or all possible combinations of the items listed together in the corresponding one of the phrases.

In the present disclosure, expressions of location relations used in the present specification such as “upper,” “lower,” “left,” and “right” are employed for the convenience of explanation, and in case drawings illustrated in the present specification are inversed, the location relations described in the specification may be inversely understood.

A vehicle (also referred to as a mobility apparatus or a mobility device) may be any apparatus or device capable of movement. A vehicle may be capable of movement by means of self-propulsion using, for example, one or more motors or engines. A vehicle may be capable of traversing over and/or across different terrains and spaces, such as land, underground, air, space, sea, and/or underwater. Land or underground vehicle may be provided, for example, in the form of automobiles, cars, trucks, buses, motorcycles, mopeds, bicycles, mobility scooters, robots, etc. Air or space vehicles may be provided, for example, in the form of air mobility apparatuses, such as fixed-wing or rotary-wing aircraft, advanced air mobility (AAM) devices, unmanned aerial vehicles, drones, rockets, or vehicles mounted on satellites. Marine or underwater vehicles may include, for example, ships, boats, jet skis, hovercraft, submarines, etc. A vehicle may move across multiple terrains or spaces.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g.,) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., objection recognition using ultrasonic data augmented by heterogeneous sensor array) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., objection recognition using ultrasonic data augmented by heterogeneous sensor array) described herein.

Minimum risk maneuver (MRM) operation(s) may also be controlled, for example, based on one or more features (e.g., objection recognition using ultrasonic data augmented by heterogeneous sensor array) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., objection recognition using ultrasonic data augmented by heterogeneous sensor array) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

An autonomous driving level and/or autonomous driving activation/deactivation may also be controlled, for example, based on one or more features (e.g., objection recognition using ultrasonic data augmented by heterogeneous sensor array) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as 5 seconds, 30 seconds, 1 minute, etc.). By changing the required user attentiveness, the driver may be required to look ahead more often (e.g., at least once in a threshold time period, such as 5 seconds, 30 seconds, 1 minute, etc.). By changing the autonomous driving level, one or more video contents may not be displayed on a display of the vehicle.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., objection recognition using ultrasonic data augmented by heterogeneous sensor array) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD), engaging and/or disengaging an autonomous driving mode, etc.).

The vehicle that an autonomous driving system is actively controlling may be referred to as an ego vehicle, a host vehicle, or an autonomous vehicle. The ego vehicle may also be referred to as a self-driving car, an autonomous car (AC), a driverless car, a robotaxi, a robotic car, or a robo-car. The ego vehicle may be the vehicle that is equipped with the autonomous driving system. Alternatively, the autonomous driving system may control the ego vehicle, for example, from an external and/or remote device, such as a server. The ego vehicle can be partially or wholly controlled (e.g., piloted, driven, etc.) remotely by a remote human driver. A car that is ahead of the ego vehicle (e.g., in the same driving lane as the ego vehicle) may be referred to as a vehicle in front (e.g., a vehicle directly in front), a vehicle ahead (e.g., a vehicle directly ahead), a lead vehicle, a leading vehicle, or a preceding vehicle. A car that follows the ego vehicle (e.g., in the same driving lane as the ego vehicle) may be referred to as a car behind, a trailing vehicle, a following vehicle, or a succeeding vehicle. An adjacent vehicle may refer to any vehicle located in any direction (e.g., front, rear, left, right, diagonal, etc.) from the ego vehicle as long as no other vehicles (e.g., intervening vehicles) exist between it and the ego vehicle (e.g., regardless of the distance from the ego vehicle). Alternatively, in some contexts, only those vehicles that are located within a threshold distance (e.g., line of sight and/or detection limit of one or more sensors of the ego vehicle) from the ego vehicle may be referred to as adjacent vehicles. A target vehicle may be any vehicle that is near the ego vehicle (e.g., within a threshold distance away from the ego vehicle). The target vehicle may be any vehicle that the autonomous driving system monitors, recognizes, identifies, tracks, and/or analyzes, either actively or passively, either once or multiple times, and either sporadically or continuously. The threshold distance may be, for example, the line of sight and/or the detection limit of one or more sensors of the ego vehicle, but the threshold distance may be a value (e.g., an adjustable value) that is less than the line of sight and/or the detection limit of the one or more sensors of the ego vehicle. The target vehicle can be, for example, a vehicle in front, a vehicle behind, a vehicle in a different lane than the driving lane of the ego vehicle (e.g., a vehicle to the left, a vehicle to the right, a vehicle in a diagonal direction, etc.), and/or an adjacent vehicle (e.g., regardless of the distance from the ego vehicle and/or regardless of whether there are intervening vehicle(s) between the target vehicle and the ego vehicle). A target vehicle may also be referred to as a surrounding vehicle, a nearby vehicle, an external vehicle, another vehicle (other vehicles), and so forth.

Hereinafter, one or more example embodiments of the present disclosure will be described with reference to the accompanying drawings.

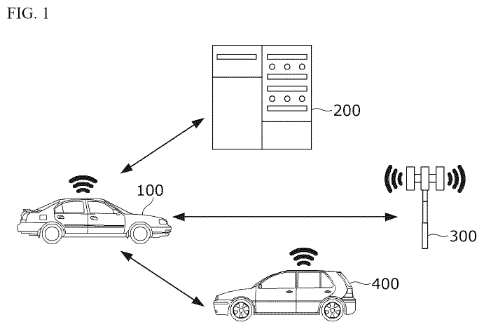

Hereinafter, a vehicle that performs object recognition using ultrasonic data augmented by heterogeneous sensor fusion (e.g., integration of data acquired from a heterogenous array of sensors) will be described with reference to FIGS. 1 to 3.

FIG. 1 is a view showing an example vehicle that communicates with another device to transmit and receive data;

Referring to FIG. 1, a vehicle 100 may be driven based on electrical energy or fossil energy. In the case of electrical energy, the vehicle 100 may be, for example, a pure battery-based vehicle driven by only a high-voltage battery or may adopt a gas-based fuel cell as an energy source. In addition, a fuel cell may use various types of gases that may generate electrical energy, and the gas may be charged to the vehicle 100, for example, in a liquefied state. Here, the gas may be, for example, hydrogen. However, the present disclosure is not limited thereto, and various gases may be applied. In the case of fossil energy, the vehicle 100 may be driven based on fuel such as gasoline, diesel, liquefied gas, etc. and provided with an internal combustion engine that drives an actuating unit 116 by combustion of the fuel. The engine may be included in a power source unit 114 from the perspective of providing a driving rotational force of a wheel to a wheel driver. As another example, the vehicle 100 may drive the actuating unit 116 selectively using an internal combustion engine based on fossil energy and the energy of an electric battery, which may be a hybrid-type vehicle.

The vehicle 100 may refer to a movable device. The vehicle 100 is a ground vehicle that travels on the ground and may be a typical passenger or commercial vehicle, a purpose built vehicle (PBV), etc. The vehicle 100 may be a four-wheeled vehicle, for example, a passenger car, a sport utility vehicle (SUV), or a small truck, or a vehicle with more than four wheels, for example, a bus, a large truck, a container transport vehicle, a heavy equipment vehicle, etc. The vehicle 100 may be a robot or an aircraft in a broad sense, such as a moving device or a means of transportation, and the robot may move using wheels, tracks, or other moving modules. The present disclosure may also be applied to robots and aircraft in addition to ground vehicles.

The vehicle 100 may be manually driven by a user or controlled by autonomous driving. The autonomous driving may be implemented as semi-autonomous driving or full autonomous driving. The full autonomous driving may be provided as autonomous movement in which a processor 120 of the vehicle 100 has full control authority without user intervention even when a traveling situation is uncertain. The semi-autonomous driving may be provided as autonomous movement that requires driver intervention depending on a specific traveling situation. The semi-autonomous driving may be implemented by allowing a user to perform manual driving by allowing the processor 120 to deactivate autonomous driving in case of situation and transferring control authority to the user. According to the level of the autonomous driving defined by the Society of Automotive Engineers (SAE), the semi-autonomous driving corresponds to autonomous driving levels 1 to 4, and the full autonomous driving corresponds to level 5.

Meanwhile, the vehicle 100 may communicate with other devices 200 and 300 or another vehicle 400. The other devices may include, for example, a server 200 for supporting various controls, state management, and traveling of the vehicle 100, an intelligent transportation system (ITS) device 300 for receiving information from an ITS, various types of user devices, etc. The server 200 may be, for example, an external device operated by a vehicle manufacturer or provided to service autonomous driving and may receive connected data of the vehicle 100 or transmit data required for manual and autonomous driving. To support autonomous driving and various services of the vehicle 100, the server 200 may transmit various types of information and software modules that are used for controlling the vehicle 100 to the vehicle 100 in response to the request and data transmitted from the vehicle 100 and the user device.

The ITS device 300 is, for example, a road side unit (RSU) and may exchange vehicle perception data, traveling control and state data, surrounding environmental data of a vehicle, map data, etc. with the vehicle 100 through vehicle-to-infrastructure (V2I) communication to assist a user driving his or her vehicle or support the autonomous driving of the vehicle 100. In the present disclosure, the ITS device 300 may be referred to as a traffic infrastructure device. The vehicle 100 may exchange the data listed above with another vehicle 400 through vehicle-to-vehicle (V2V) communication to support manual driving or autonomous driving.

The vehicle 100 may communicate with another vehicle or other devices based on cellular communication, wireless access in vehicular environment (WAVE) communication, dedicated short range communication (DSRC), short-range communication, or other communication methods.

For example, the vehicle 100 may use a communication network such as Long Term Evolution (LTE) or 5G, a Wi-Fi communication network, a WAVE communication network, etc. as a cellular communication network to communicate with the server 200, the ITS device 300, and another vehicle 400. As another example, DSRC or the like used in the vehicle 100 may be used for communication between vehicles. A communication method between the vehicle 100, the server 200, the ITS device 300, another vehicle 400, and the user device is not limited to the example embodiment(s) herein.

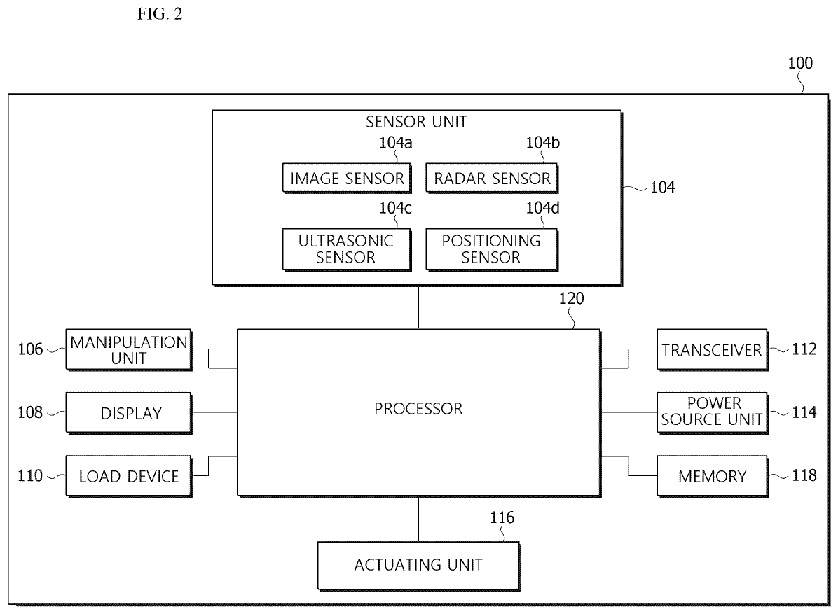

FIG. 2 is a view showing modules constituting an example vehicle.

The vehicle 100 may include a sensor unit 104, a manipulation unit 106, a display 108, a load device 110, and a transceiver 112.

The sensor unit 104 may include various types of sensors for detecting various states and situations that occur in an external surrounding environment, internal system, user manipulation, and boarding space of the vehicle 100.

Specifically, the sensor unit 104 may include an outward-facing image sensor 104a, a radar sensor 104b, an ultrasonic sensor 104c, etc. to recognize dynamic and static objects which are present around the vehicle 100.

The image sensor 104a may recognize an external object as an image while the vehicle 100 is being used to generate image data and transmit the image data to the processor 120. The image sensor 104a may be installed on a plurality of portions of the vehicle 100 so that a plurality of images or multi-views of the surrounding environment of the vehicle 100 may be acquired.

The radar sensor 104b may emit radio waves of a specific frequency to a peripheral area of the vehicle 100 to generate radar data through radio waves reflected from an external object in order to identify the presence, relative distance, speed, direction, etc. of the external object. The radar data may be generated as point cloud data similar to lidar data.

In the present disclosure, the image sensor 104a and the radar sensor 104b may be a combination example of heterogeneous sensors, and the heterogeneous sensor may include at least one of the image sensor 104a and the radar sensor 104b.

In addition, the sensor unit 104 may have the ultrasonic sensor 104c for detecting an external object that is present in a short-range area around the vehicle 100. The ultrasonic sensor 104c may emit ultrasonic waves around the vehicle 100 to generate ultrasonic data through sound waves reflected from the external object in order to identify, for example, the presence of an object, a position of the object, a relative distance to the object, etc. The ultrasonic sensor 104c may detect an object in a short-range area wider than a detection range of the radar sensor 104b. The ultrasonic sensor 104c may output ultrasonic data having a lower data density, for example, a point cloud density, than the radar sensor 104b. That is, the ultrasonic data may be output sparsely (e.g., output data with a lower resolution) compared to the radar sensor 104b. In addition, the ultrasonic sensor 104c may acquire the surrounding environment at a higher cycle than the heterogeneous sensor to generate ultrasonic data. For example, an acquisition cycle of the image sensor 104a may be about 33 ms, an acquisition cycle of the radar sensor 104b may be about 50 ms, but an acquisition cycle of the ultrasonic sensor 104c may be about 140 ms. The ultrasonic data may be acquired with a smaller amount of data than the heterogeneous sensor due to the above matters.

The sensor unit 104 may include a positioning sensor 104d for identifying a position of the vehicle 100. The positioning sensor 104d may be, for example, a global positioning system (GPS) sensor or a global navigation satellite system (GNSS) sensor, but is not limited thereto.

In addition, although not shown in FIG. 2, the sensor unit 104 may include a speed sensor and an attitude sensor. The speed sensor may detect, for example, a longitudinal speed, longitudinal acceleration, wheel steering angular speed, wheel steering angular acceleration, etc. of the vehicle 100. The attitude sensor may detect, for example, a three-axis state of the vehicle 100, for example, yaw, pitch, and roll, and output various attitude states of the vehicle based on the above factors. Examples of the attitude sensor may include an inertia measurement unit (IMU) sensor, a gyro sensor, etc. In addition, the present disclosure describes an example in which a lidar sensor is not mounted, but the sensor unit 104 may further include a lidar sensor (not shown) according to the specifications of the vehicle 100.

The sensors of the sensor unit 104 referred to in the description of the present disclosure are mainly described, but sensors for detecting various situations, which are not listed above, may be additionally included.

The manipulation unit 106 may be formed as a module manipulated by a user for driving. For example, the manipulation unit 106 may be a steering wheel for manual driving, an automatic or manual transmission, an accelerator pedal, a brake pedal, a gear transmission, etc. The manipulation unit 106 may further include an interface for using, deactivating, and selecting a specific function of an autonomous driving mode requested by the user so that the user may use the autonomous driving function. To receive various requests related to autonomous driving, the manipulation unit 106 may be composed of, for example, a hard type interface provided at a predetermined location in the vehicle 100 or a soft type interface that may be touched on the display 108.

The display 108 may serve as a user interface. The display 108 may be controlled by the processor 120 to display an operation state, control state, route/traffic information, and the remaining energy information of the vehicle 100, content requested by a driver, etc. In addition, the display 108 may be formed as a touch screen capable of detecting the input of the driver to receive the request of the driver that instructs the processor 120.

The load device 110 may be mounted on the vehicle 100 and may be a type of non-driving electric device excluding a driving power system such as the wheel driver or the like. The load device 110 is an auxiliary device for receiving power from the power source unit 114 and may be, for example, an air conditioning system, a lighting system, a seat system, and various devices installed on the vehicle 100.

The transceiver 112 may support mutual communication with the server 200, the ITS device 300, a nearby vehicle 400, etc. The transceiver 112 may include, for example, a module for processing cellular communication, WAVE communication, DSRC, etc. In the present disclosure, the transceiver 112 may transmit data generated or stored during driving to the server 200 and receive data and a software module transmitted from the server 200. The transceiver 112 may support communication with an electronic device of a passenger in the vehicle 100. In the present disclosure, the vehicle 100 may transmit and receive data used in the method according to the present disclosure with an external device through the transceiver 112.

In addition, the vehicle 100 may include the power source unit 114 and the actuating unit 116.

The power source unit 114 may generate and supply power and electric power that are used in a driving power system such as the actuating unit 116 and a non-driving power system. The non-driving power system may include, for example, the sensor unit 104, the manipulation unit 106, the display 108, the load device 110, the transceiver 112, etc., but is not limited thereto, and may include various components for implementing sensing, interface, communication, and convenience functions other than components directly involved in driving operations.

When the vehicle 100 is driven based on electrical energy, the power source unit 114 may be formed as, for example, an electric battery charged from the outside or formed as a combination of an electric battery and a fuel cell that charges the battery. In the case of a combination of the electric battery and the fuel cell, the power source unit 114 may include a tank that stores a material used to produce power for the fuel cell, for example, liquefied hydrogen. When the vehicle 100 is driven based on fossil energy, the power source unit 114 may be formed as an internal combustion engine. In addition, when the vehicle 100 is a hybrid type, the power source unit 114 may be provided as a combination of the internal combustion engine and the electric battery.

The actuating unit 116 may include at least one module that implements a driving operation and perform at least one driving operation of longitudinal control such as acceleration and deceleration and lateral control such as steering, and gear shifting according to a user request from the manipulation unit 106 or a request of the processor 120. Here, the gear shifting may be processed by a request of a manual driving user using a gear transmission or a request of the processor 120 in autonomous driving.

The actuating unit 116 may have a wheel driver (not shown) and a mechanical component and an electronic module for implementing a driving operation in the wheel driver in order to perform a driving operation according to a command of the processor 120 by a manual manipulation of the user or autonomous driving. When the vehicle 100 is operated based on electrical energy, the vehicle 100 may include an assembly for transmitting the requested driving operation to the wheel driver. When the vehicle 100 is operated based on fossil energy, the actuating unit 116 may include a transmission and a gear module for transmitting the power of an internal combustion engine.

The wheel driver may include a plurality of wheels, a driving force generation module for generating a driving force to impart the driving force to wheels or transmitting the driving force, a brake module for decelerating the driving of the wheels, a steering module for achieving lateral control of the wheels, etc. When the vehicle 100 is driven based on electrical energy, the driving force generation module may be provided as a motor assembly for generating a driving force based on the power output from the electric battery. The brake module of the electric-based vehicle 100 may further have a regenerative brake function.

In addition, the vehicle 100 may include a memory 118 and the processor 120.

The memory 118 may store applications and various types of data for controlling the vehicle 100 and load the applications or read or write the data at the request of the processor 120. In the present disclosure, the memory 118 may include an example according to the present disclosure, that is, an application that fuses image data, radar data, and ultrasonic data generated based on the image sensor 104a, the radar sensor 104b, and the ultrasonic sensor 104c, respectively, and processes at least one task using the fused information.

The task may include, for example, object detection processing, semantic segmentation processing, and view map generation processing. The view map may represent or depict an environment such as the external (e.g., surrounding) environment of a vehicle. The view map may be generated to include a predetermined view perspective and pieces of object information related to objects detected by the sensors 104a to 104c. The task is not limited to the above example and may include various types of processing that supports vehicle control.

The task may be performed by, for example, a learning model. The object detection processing may be executed to generate, for example, a boundary area (e.g., a bounding box) surrounding an object in a common space and a type (or a class) of the object. The semantic segmentation processing may be performed, for example, to indicate an occupied area of the object in the common space.

The view map may be generated as a bird's eye view (BEV) map having a view of the vehicle 100 from above (e.g., a bird's eye view of the vehicle 100 and its environment as viewed from above the vehicle 100). The vehicle 100 may be a type of sensor-mounted device having one or more sensors 104a to 104c for detecting a surrounding environment in the present disclosure. The BEV map may have a view provided in a vertical direction from above the vehicle 100 to the ground. The ground may be a point at which the vehicle 100 is positioned. The object information of the view map may be generated, for example, by fusing (e.g., integrating, combining, synthesizing, etc.) data of the sensors 104a to 104c in a fusion space in which the sensors 104a to 104c are connected. The object information may include, for example, a position of the object, a speed of the object, a direction of the object, a shape of the object, a type (or a class) of the object, object estimation reliability, etc. In addition, the object information may include tracking information for object tracking. The tracking information may be used, for example, for predicting an object recognition area based on data acquired from at least one of the plurality of sensors 104a to 104c, association with a subsequently acquired object recognition area, and tracking the associated object recognition area. The tracking information may include, for example, a tracking area surrounding an object identified as a target, a track identifier, and information about an object in the tracking area. The information about the object in the tracking area may include a position, a tracking speed, a direction, a shape, a class, etc. The direction of the tracking area may include, for example, an azimuth defined as an angle of an object with respect to a vehicle, and an orientation angle according to an orientation direction of the object.

Regarding the present disclosure, the application may generate pseudo-ultrasonic data using at least one piece of data of object information of the view map and process a task based on the pseudo-ultrasonic data and heterogeneous sensor data by actual detection.

The processor 120 may perform the overall control of the vehicle 100. The processor 120 may be configured to execute applications and instructions that are stored in the memory 118. The processor 120 may generate control instructions for components of the vehicle 100 according to driving control requests in manual driving and autonomous driving. The component may be at least one of various members described in FIG. 2.

The processor 120 may at least execute various processes related to object recognition and generation of the pseudo-ultrasonic data used for the object recognition according to the present disclosure.

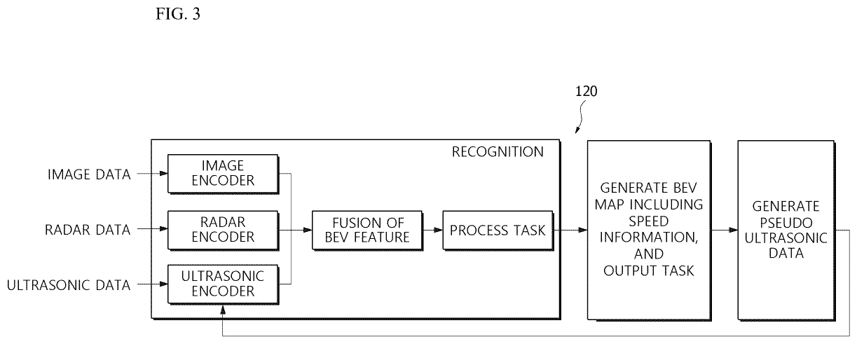

The processor 120 for processing object recognition and generation of pseudo-ultrasonic data will be described with reference to FIG. 3. FIG. 3 is a schematic view showing an example processor for object recognition using ultrasonic data augmented by heterogeneous sensor fusion (e.g., a heterogenous sensor array or integration of data acquired from such a heterogenous sensor array).

Each of the image sensor 104a, the radar sensor 104b, and the ultrasonic sensor 104c may actually detect the surrounding environment and generate image data, radar data, and ultrasonic data. The processor 120 may execute perception processing that processes a task based on the image data, the radar data, and the ultrasonic data.

Regarding perception processing, an image encoder may generate an image feature map including image features based on the image data. Since the image data is acquired from a plurality of cameras or generated in a space different from the view map, the image feature map may be transformed into a view feature map having image features by view transform processing so that the image feature map is projected into a space of the view map. For convenience of description, the view map may be exemplified as the BEV map. A radar encoder may generate a BEV feature map including radar features based on the radar data. An ultrasonic encoder may generate the BEV feature map including ultrasonic features based on the ultrasonic data.

Each encoder may use, for example, a convolutional neural network (CNN). Specifically, each encoder may include various modules for generating a convolutional layer, a filter, and a feature map. The module may process, for example, the projection of features onto the BEV feature map.

Regarding perception processing, the fusion (e.g., combination, integration, synthesis, etc.) of the BEV feature may fuse image features, radar features, and ultrasound features into a common space and output an integrated BEV feature map. The integrated BEV feature map may be generated, for example, by summing or concatenating the features of the sensors 104a to 104c.

The task may generate perception information according to the corresponding task based on the integrated BEV feature map. As described above, the task may include at least one of object detection processing, semantic segmentation processing, and BEV map generation processing. The BEV map may include object information that fuses data output from the sensors 104a to 104c. In the present disclosure, the task may be a multi-task that executes the above processing in parallel based on the BEV feature map. The task may include, for example, a decoder for generating perception information according to each processing.

The processor 120 may generate speed information for each cell of the BEV map based on the object information of the BEV map and execute processing for generating a BEV map including the speed information. A cell may be any information unit (e.g., smallest unit data) that represents sensor data. For example, a cell may correspond to a pixel on the BEV map. A cell may correspond to a unit data that constitutes sensor data acquired from a sensor. The quantity of cells in sensor data may correspond to the resolution of the sensor data. For example, data acquired from a high-resolution sensor may thus have a greater number of cells than data acquired from a low-resolution sensor. The speed information may indicate, for example, a speed of a dynamic object that corresponds to a cell in the view map. In addition, the processor 120 may execute processing for adjusting (e.g., correcting) the position of the cell corresponding to the dynamic object based on the behavior of the dynamic object around the vehicle 100. Meanwhile, the task output according to the object detection processing and the semantic segmentation processing may be used for vehicle control.

The processor 120 may execute processing for generating pseudo-ultrasonic data based on speed information of the position-adjusted cell. The processor 120 may perform processing for recognizing an object based on the pseudo-ultrasonic data and subsequent heterogeneous sensor data. Specifically, the image data and radar data input to the perception processing may be actually acquired from the image sensor 104a and the radar sensor 104b. On the other hand, the pseudo-ultrasound data may not be actually acquired from the ultrasound sensor 104c, but may be virtual ultrasound data augmented based on the fusion (e.g., combination, integration, synthesis, etc.) of ultrasound data and heterogeneous sensor data.

In the present disclosure, the processor 120 is, for example, formed as a single processing module. As another example, the processor 120 may be composed of a plurality of processing modules so that the above processing may be performed by the processing modules.

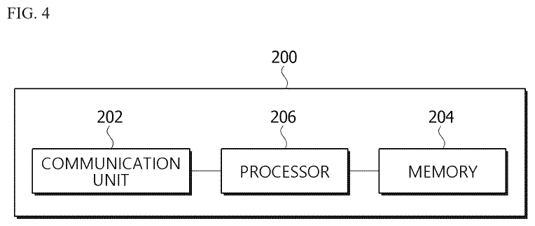

FIG. 4 is a view showing modules constituting an example server.

The server 200 may transmit response data according to the request of the vehicle 100 to the vehicle 100 and also transmit information for supporting an application embedded in the vehicle 100 and vehicle driving to the vehicle 100. The server 200 may include a communication unit 202, a memory 204, and a processor 206.

The communication unit 202 may transmit and receive data with an external device, support mutual communication with the vehicle 100 in the present disclosure, and exchange data with the vehicle 100.

The memory 204 may store a program and various types of data for operating the server 200 and load the program or read and record the data at the request of the processor 206. The memory 204 may store and manage a program for processing a request of the vehicle 100, an application embedded in the vehicle 100, and information for supporting driving. The memory 118 may store, for example, a database and map information used to identify an object detected by the image sensor 104a.

The processor 206 may perform the overall control of the server 200. The server 200 may be configured to execute the program and instructions that are stored in the memory 204. The processor 206 may execute the program to process and response to a user request transmitted from the vehicle 100. For example, the processor 206 may transmit a database and map information used to identify the object detected by the image sensor 104a at the request of the vehicle 100.

In the present disclosure, the processor 206 is, for example, formed as a single processing module. As another example, the processor 206 may be composed of a plurality of processing modules so that the above processing may be performed by the processing modules.

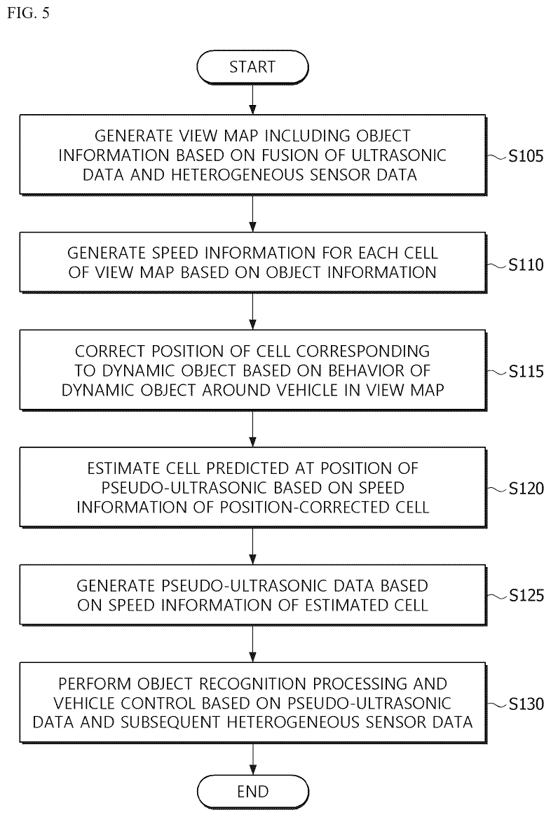

Hereinafter, an object recognition method using ultrasonic data augmented by the fusion (e.g., combination, integration, synthesis, etc.) of a radar heterogeneous sensor will be described in detail with reference to FIG. 5. FIG. 5 is a flowchart of an example object recognition method using ultrasonic data augmented by heterogeneous sensor fusion. The method of the present disclosure is performed by the processor 120, but, for convenience of description, the processor 120 and the vehicle 100 may be described interchangeably.

Referring to FIG. 5, the processor 120 of the vehicle 100 may generate a view map including object information based on the fusion of ultrasonic data and heterogeneous sensor data (S105).

The heterogeneous sensor data may be acquired from at least one of the image sensor 104a and the radar sensor 104b. For convenience of description, the heterogeneous sensor data may be described as including the image data of the image sensor 104a and the radar data of the radar sensor 104b.

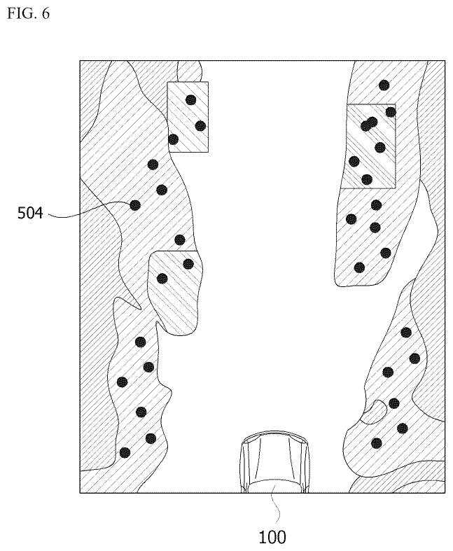

The ultrasonic data may be acquired from the ultrasonic sensor 104c. As shown in FIG. 6, ultrasonic data 504 detects an object positioned at a short distance around the vehicle 100. FIG. 6 is a view showing a location detected based on example ultrasonic data. The detection position of FIG. 6 is marked in the perception information of the semantic segmentation processing. Ultrasonic data may be acquired with a longer acquisition cycle than heterogeneous sensor data and may include sparse data with a lower density than heterogeneous sensor data, for example, radar data.

The view map may be generated by the view map generation processing of the perception processing of FIG. 3. The view map may be provided to fuse image features, radar features, and ultrasonic features and include object information based on the fused features. Since the generation of the view map has been described in FIG. 3, the description thereof will be omitted. For convenience of description, the view map is exemplified as a BEV map, and the view map may be described interchangeably with the BEV map.

The processor 120 may generate speed information for each cell of the view map based on the object information (S110).

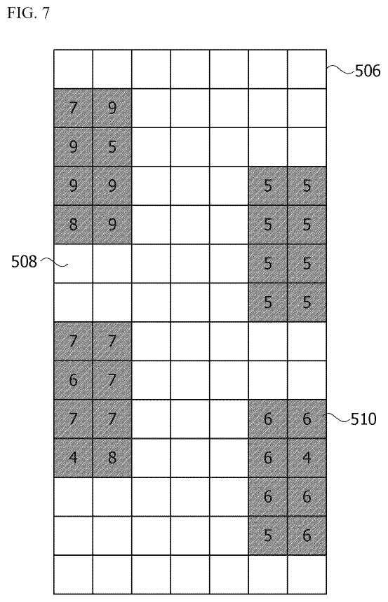

The BEV map, which is a type of a view map 506, may have a plurality of cells 508 arranged as shown in FIG. 7. FIG. 7 is a view showing an example view map including speed information. In the present disclosure, the cells 508 may be referred to as pixels or grid cells. The view map 506 may be provided to indicate cells of static objects and dynamic objects.

As shown in FIG. 7, the processor 120 may generate speed information for each of the cells 508 based on the object information provided from the view map 506. The speed information may be provided to cells 510 identified as dynamic objects. Specifically, the speed information may be generated for each of the cells 510 based on data related to the speed of the object information, for example, a tracking speed and a Doppler speed.

The object information may include, for example, a position of the object, a speed of the object, a shape of the object, a size of the object, tracking information, and a speed detected by a single sensor. The Doppler speed of the radar sensor 104b may be a type of speed of the object detected by a single sensor. The Doppler speed may be a speed (e.g., relative speed) detected based on the Doppler shift of the radar sensor 104b. The tracking information may include, for example, a tracking area provided by fusing data from the plurality of sensors 104a to 104c, a tracking speed of the tracking area, a direction of the tracking area, a class of the tracking area, and a size of the tracking area. The tracking speed of an object according to object tracking may use the tracking speed of the tracking area or may be the speed of the object.

Referring to FIG. 5, the processor 120 may adjust (e.g., correct) the positions of the cells 510 corresponding to dynamic objects based on the behavior of the dynamic objects around the vehicle 100 in the view map 506 (S115).

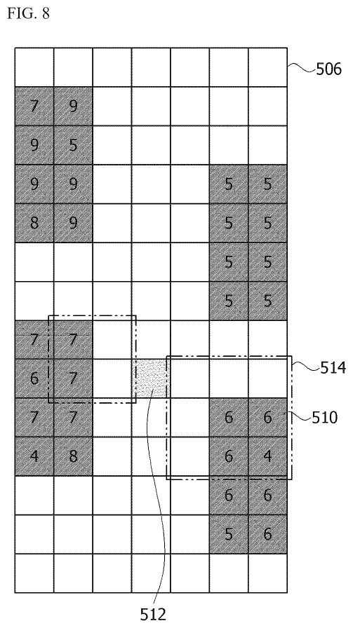

The processor 120 may arrange patch(es) 514 on the view map 506 as shown in FIG. 8. FIG. 8 is a view showing an example process of identifying a dynamic object around a vehicle. The patch(es) 514 may be arranged to have a predetermined cell size (e.g., a predetermined size having a predetermined quantity of cells) around the vehicle 100 in the view map 506, for example, based on the detection range of the ultrasonic sensor 104c. In FIG. 8, the patch(es) 514 may be arranged adjacent to the cell(s) 512 of a host vehicle.

The processor 120 may identify whether a dynamic object is present in the patch(es) 514. The identification of the dynamic object may be performed, for example, by referring to an object class. The processor 120 may adjust (e.g., correct) the position of the cell of the dynamic object based on the behavior of the dynamic object and the size of the dynamic object that are estimated from motion data of the identified dynamic object. The motion data of the dynamic object may include, for example, at least one of a motion vector of the dynamic object and a direction of the dynamic object. The position adjustment (e.g., correction) of the cells 510 may use a motion estimation model.

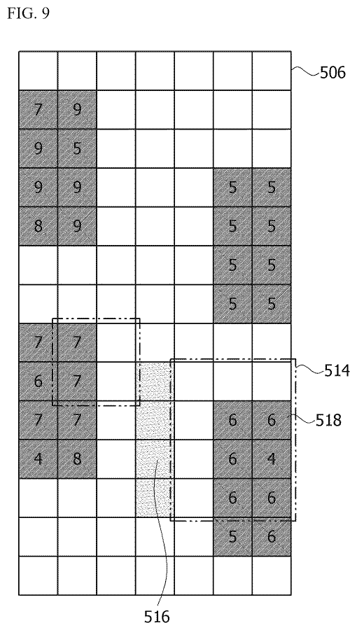

As shown in FIG. 9, the position adjustment (e.g., correction) of the cells 518 may be performed to change the positions of the cells 510 including the speed information shown in FIG. 8 in the view map 506 based on the behavior of the dynamic object and the size of the dynamic object. FIG. 9 is a view showing an example process of adjusting a position of a cell of the dynamic object. In addition, as shown in FIG. 9, positions of predicted cells 516 where the host vehicle is expected to move may be estimated in the view map 506 based on the behavior and speed of the vehicle 100, and the position-adjusted cells 518 may be estimated by referring to the predicted cells 516 of the host vehicle.

Referring to FIG. 5, the processor 120 may estimate cells predicted at the positions of the pseudo-ultrasonic data in the view map 506 based on the speed information of the position-adjusted cells 518 (S120).

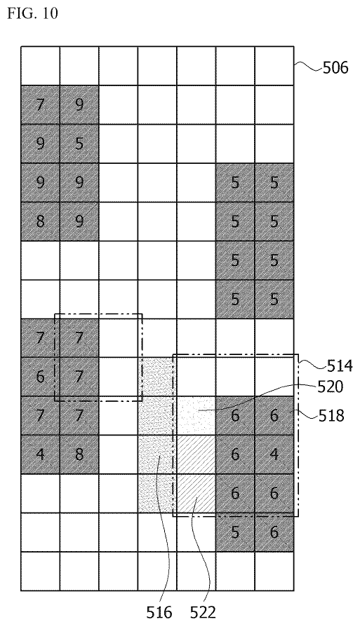

As shown in FIG. 10, estimated cells 522 predicted at the positions of the pseudo-ultrasonic data may be provided on the view map 506 based on the speed information of the position-adjusted cells 518 and the predicted cells 516 of the host vehicle. FIG. 10 is a view showing an example process of predicting an estimated cell corresponding to a position of pseudo-ultrasonic data. The estimated cells 522 may be positioned differently from the detected cells 520 corresponding to the detected positions of the ultrasonic data. The detected cells 520 may be positions at which the ultrasonic data is actually detected at the position of the vehicle 100 in the predicted cells 512 of the host vehicle shown in FIG. 8. The estimated cells 522 may be virtual positions of the ultrasonic data in the dynamic object generated by reflecting the movement of the dynamic object and the behavior of the vehicle 100.

Referring to FIG. 5, the processor 120 may generate the pseudo-ultrasonic data based on pieces of speed information related to the estimated cells 522 (S125).

As shown in FIG. 10, the processor 120 may generate pseudo-ultrasonic data based on pieces of speed information of cells corresponding to or closest to the estimated cells 522. The processor 120 may generate pseudo-ultrasonic data to have an estimated distance between the vehicle 100 and the dynamic object based on the pieces of speed information related to the estimated cells 522. In addition, the processor 120 may output the pseudo-ultrasonic data to further include the position of the dynamic object with respect to the vehicle 100 based on the estimated distance.

Referring back to FIG. 5, the processor 120 may process object recognition based on the pseudo-ultrasonic data and subsequent heterogeneous sensor data and perform vehicle control using the perception information according to the above processing (S130).

The subsequent heterogeneous sensor data may be sensor data acquired by at least one of the image sensor 104a and the radar sensor 104b after operation S105. Here, since the ultrasonic sensor 104c has not reached the acquisition cycle, pseudo-ultrasonic data may be used for processing of object recognition. However, when the ultrasonic data is actually acquired according to the acquisition cycle, even when the pseudo-ultrasonic data is generated, actual ultrasonic data may be input into the processing of object recognition. The processing of object recognition may be at least one of the types of processing shown in FIG. 3. The perception information according to the processing may be used, for example, for autonomous driving control and driving assistance control.

According to an object recognition method and a vehicle of the present disclosure, by augmenting ultrasonic sensor data based on fusion information of heterogeneous sensors, it is possible to increase the accuracy of object recognition and increase the usability of ultrasonic sensor data.

In addition, the recognition performance of a short-range object can be reinforced by fusing augmented ultrasonic sensor data and heterogeneous sensor data.

Effects obtainable from the present disclosure are not limited to the above-described effects, and other effects that are not described will be able to be clearly understood by those skilled in the art to which the present disclosure pertains based on the following description.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various example embodiment(s) of the present disclosure are not a list of all possible combinations and are intended to describe representative aspects of the present disclosure, and the matters described in the various example embodiment(s) may be applied independently or in combination of two or more.

In addition, various example embodiment(s) of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

According to the present disclosure, there is provided an object recognition method using ultrasonic data augmented by heterogeneous sensor fusion, the method comprising: generating speed information for each cell of a view map based on fusion of ultrasonic data and heterogeneous sensor data; correcting a position of a cell corresponding to a dynamic object based on behavior of the dynamic object around a sensor-mounted device in the view map; generating pseudo-ultrasonic data based on speed information of the position-corrected cell; and recognizing an object based on the pseudo-ultrasonic data and subsequent heterogeneous sensor data.

According to the present disclosure in the method, the ultrasonic data may be acquired from an ultrasonic sensor, and the heterogeneous sensor data may be acquired from at least one of an image sensor and a radar sensor.

According to the present disclosure in the method, the heterogeneous sensor data may be acquired from at least a radar sensor, the speed information may be generated for each cell based on a tracking speed according to tracking of the object and a Doppler speed of the radar sensor, and the Doppler speed may be a speed detected based on a Doppler shift of the radar sensor.

According to the present disclosure in the method, the correcting of the position of the cell may include correcting the position of the cell of the dynamic object based on the behavior estimated from motion data of the dynamic object and a size of the dynamic object.

According to the present disclosure in the method, the correcting of the position of the cell may include correcting the position of the cell in the dynamic object belonging to patches arranged in the view map, and the patches may be arranged to have a predetermined cell size around the sensor-mounted device in the view map based on a detection range of the ultrasonic sensor that generates the ultrasonic data.

According to the present disclosure in the method, the generating of the pseudo-ultrasonic data may include generating the pseudo-ultrasonic data including an estimated distance between the sensor-mounted device and the dynamic object based on the speed information of the position-corrected cell.

According to the present disclosure in the method, the generating of the pseudo-ultrasonic data may include: estimating a cell predicted at a position of the pseudo-ultrasonic data in the view map based on the speed information of the position-corrected cell; and generating the pseudo-ultrasonic data based on speed information related to the estimated cell.

According to the present disclosure in the method, an acquisition cycle of the ultrasonic data may be set to be higher than an acquisition cycle of the heterogeneous sensor data.

According to the present disclosure in the method, the view map may be generated as a bird's eye view map having a view toward the sensor-mounted device from above the sensor-mounted device.

According to the present disclosure in the method, the recognizing of the object may include performing at least one of object detection processing and semantic segmentation processing based on the pseudo-ultrasonic data and the subsequent heterogeneous sensor data.

According to the present disclosure, there is provided a vehicle that implements object recognition using ultrasonic data augmented by heterogeneous sensor fusion, the vehicle comprising: a sensor unit including an ultrasonic sensor configured to output ultrasonic data and a heterogeneous sensor configured to output heterogeneous sensor data in relation to detection of a surrounding environment; a memory configured to store at least one instruction; and at least one processor configured to execute the at least one instruction stored in the memory. The at least one processor is configured to: generate speed information for each cell of a view map based on fusion of the ultrasonic data and the heterogeneous sensor data; correct a position of the cell corresponding to a dynamic object based on behavior of the dynamic object around a sensor-mounted device in the view map; generate pseudo-ultrasonic data based on speed information of the position-corrected cell; and recognize an object based on the pseudo-ultrasonic data and subsequent heterogeneous sensor data.

The features briefly summarized above for this disclosure are only exemplary aspects of the detailed description of the disclosure which follow, and are not intended to limit the scope of the disclosure.

The scope of the disclosure includes software or machine-executable commands (e.g., an operating system, an application, firmware, a program, etc.) for enabling operations according to the methods of various example embodiment(s) to be executed on an apparatus or a computer, a non-transitory computer-readable medium having such software or commands stored thereon and executable on the apparatus or the computer.

What is claimed is:

1. A method performed by a device associated with a vehicle, the method comprising:
generating, based on sensor fusion of ultrasonic data and heterogeneous sensor data acquired from a plurality of sensors of the vehicle, speed information associated with each cell of a view map, wherein the view map represents a surrounding environment of the vehicle, and wherein the speed information indicates a speed of the dynamic object corresponding to the cell;
adjusting, based on a behavior of a dynamic object in the view map, a position of a cell, of the view map, corresponding to the dynamic object in the surrounding environment;
generating, based on speed information of the position-adjusted cell, pseudo-ultrasonic data;
recognizing, based on the pseudo-ultrasonic data and subsequent heterogeneous sensor data, an object in the surrounding environment; and
controlling, based on the recognized object, an operation of the vehicle.

2. The method of claim 1, wherein the ultrasonic data is acquired from an ultrasonic sensor, and the heterogeneous sensor data is acquired from at least one of an image sensor or a radar sensor.

3. The method of claim 1, wherein the heterogeneous sensor data is acquired from at least a radar sensor, wherein the speed information associated with each cell is generated further based on a Doppler speed, of the object, detected by the radar sensor, and wherein the Doppler speed is a speed detected based on a Doppler shift of data acquired by the radar sensor.

4. The method of claim 1, wherein the adjusting of the position of the cell comprises adjusting of the position of the cell further based on a size of the dynamic object, and wherein the behavior of the dynamic object is estimated based on motion data of the dynamic object.

5. The method of claim 1, wherein the adjusting of the position of the cell comprises determining the cell inside a patch of cells of the view map, and
wherein the patch of cells is located around one or more cells, of the view map, that correspond to the device, and
wherein a size of the patch of cells is based on a detection range of an ultrasonic sensor that generates the ultrasonic data.

6. The method of claim 1, wherein the generating of the pseudo-ultrasonic data comprises determining, based on the speed information associated with the position-adjusted cell, an estimated distance between the device and the dynamic object.

7. The method of claim 1, wherein the generating of the pseudo-ultrasonic data comprises:
determining, based on the speed information associated with the position-adjusted cell, an estimated cell, of the view map, corresponding to a predicted position associated with the pseudo-ultrasonic data; and
generating, based on speed information associated with the estimated cell, the pseudo-ultrasonic data.

8. The method of claim 1, wherein an acquisition cycle of the ultrasonic data is longer than an acquisition cycle of the heterogeneous sensor data.

9. The method of claim 1, wherein the view map comprises a bird's eye view map of the device and the surrounding environment as viewed from above the device.

10. The method of claim 1, wherein the recognizing of the object comprises performing, based on the pseudo-ultrasonic data and the subsequent heterogeneous sensor data, at least one of object detection processing or semantic segmentation processing.

11. A vehicle comprising:
a plurality of sensors comprising:
an ultrasonic sensor configured to output ultrasonic data associated with a surrounding environment of the vehicle; and
a heterogeneous sensor array configured to output heterogeneous sensor data associated with the surrounding environment of the vehicle;
a processor; and
a memory storing at least one instruction that is configured, when executed by the processor communicating with the memory, to cause the vehicle to:
generate, based on sensor fusion of the ultrasonic data and the heterogeneous sensor data, speed information associated with each cell of a view map, wherein the view map represents the surrounding environment;
adjust, based on a behavior of a dynamic object in the view map, a position of a cell, of the view map, corresponding to the dynamic object in the surrounding environment;
generate, based on speed information associated with the position-adjusted cell, pseudo-ultrasonic data;
recognize, based on the pseudo-ultrasonic data and subsequent heterogeneous sensor data, an object in the surrounding environment; and
control, based on the recognized object, an operation of the vehicle.

12. The vehicle of claim 11, wherein the heterogeneous sensor array comprises at least one of an image sensor or a radar sensor.

13. The vehicle of claim 11, wherein the heterogeneous sensor array comprises at least a radar sensor, wherein the speed information associated with each cell is generated further based on a Doppler speed, of the object, detected by the radar sensor, and wherein the Doppler speed is a speed detected based on a Doppler shift of data acquired by the radar sensor.

14. The vehicle of claim 11, wherein the at least one instruction is configured, when executed by the processor communicating with the memory, to cause the vehicle to adjust the position of the cell by adjusting of the position of the cell further based on a size of the dynamic object, and the behavior of the dynamic object is estimated based on motion data of the dynamic object.

15. The vehicle of claim 11, wherein the at least one instruction is configured, when executed by the processor communicating with the memory, to cause the vehicle to adjust the position of the cell by determining the cell inside a patch of cells of the view map, and
wherein the patch of cells is located around one or more cells, of the view map, that correspond to the vehicle, and
wherein a size of the patch of cells is based on a detection range of the ultrasonic sensor.

16. The vehicle of claim 11, wherein the at least one instruction is configured, when executed by the processor communicating with the memory, to cause the vehicle to generate the pseudo-ultrasonic data by:
determining, based on the speed information associated with the position-adjusted cell, an estimated distance between the vehicle and the dynamic object.

17. The vehicle of claim 11, wherein the at least one instruction is configured, when executed by the processor communicating with the memory, to cause the vehicle to generate the pseudo-ultrasonic data by:
determining, based on the speed information associated with the position-adjusted cell, an estimated cell, of the view map, corresponding to a predicted position associated with the pseudo-ultrasonic data; and
generating, based on speed information associated with the estimated cell, the pseudo-ultrasonic data.

18. The vehicle of claim 11, wherein an acquisition cycle of the ultrasonic data is longer than an acquisition cycle of the heterogeneous sensor data.

19. The vehicle of claim 11, wherein the view map comprises a bird's-eye view map of the vehicle and the surrounding environment as viewed from above the vehicle.

20. The vehicle of claim 11, wherein the at least one instruction is configured, when executed by the processor communicating with the memory, to cause the vehicle to recognize the object by:
performing, based on the pseudo-ultrasonic data and the subsequent heterogeneous sensor data, at least one of object detection processing or semantic segmentation processing.
